(19) United States
(12) Patent Application Publication
(10) Pub. No.: US 2024/0030792 A1
(43) Pub. Date: Jan. 25, 2024

(54) STACKING METHOD FOR STACKING WAVE WINDING WIRES, MAGAZINE FOR USE THEREIN AND USES THEREOF

(71) Applicant: GROB-WERKE GmbH & Co. KG, MINDELHEIM (DE)

(72) Inventors: Georg SCHRETZENMAIER, BURGAU (DE); Markus SCHMÖLZ, RIEDEN (DE); Ralf RAUSCHER, FELLHEIM (DE)

(21) Appl. No.: 18/356,641

(22) Filed: Jul. 21, 2023

(30) Foreign Application Priority Data
Jul. 22, 2022 (DE) 102022118399.8
Oct. 19, 2022 (EP) 22202369.9

(51) Int. Cl. H02K 15/04; B21F 3/08

(52) U.S. Cl. CPC H02K 15/0478; B21F 3/08

(57) ABSTRACT

A method of stacking wave winding wires (wires) for forming a winding mat for a stator coil winding including providing a drop magazine containing a plurality of similar wires in a receiving space, wherein a receiving space contour is configured to the received wires, such that the wires are positioned at a plurality of guide devices at different receiving space boundary locations and guided through the receiving space without changing their geometry, positioning a workpiece carrier having a retaining structure for a winding mat formed of multiple stacked wires in a first transfer position below the magazine and depositing a wire from the magazine at a first position on the workpiece carrier, positioning the workpiece carrier in a second transfer position offset from the first transfer position below the magazine, and depositing a further wire from the magazine at a position offset from the first position on the workpiece carrier.

### CROSS-REFERENCES TO RELATED APPLICATIONS

This application claims the benefit of the German Application No. 102022118399.8, filed on Jul. 22, 2022, and of the European patent application No. 22202369.9 filed on Oct. 19, 2022, the entire disclosures of which are incorporated herein by way of reference.

### FIELD OF THE INVENTION

The invention relates to a stacking method for stacking wave winding wires to form a winding mat for a coil winding of a stator. The invention further relates to a manufacturing method for manufacturing a winding mat for a coil winding of a stator, the manufacturing method including stacking of wave winding wires using the stacking method. Further, the invention relates to a magazine for use in the stacking method, a stacking device for stacking wave winding wires comprising at least one such magazine, a controller and a computer program for such a stacking device, and a manufacturing device for manufacturing a wave winding mat provided with such a stacking device.

### BACKGROUND OF THE INVENTION

For the definition of the terms and the technological background, reference is made to the following literature:
[1] DE 11 2006 000 742 A1
[2] DE 11 2019 004 024 A1
[3] EP 2 219 284 A1
[4] WO 2019/0 166 061 A1—U.S. Pat. No. 11,394,281
[5] DE 103 28 956 A1
[6] US 2009/0 322 178 A1
[7] DE 10 2020 130 647 A1
[8] WO 2019/0 020 148 A1
[9] WO 2018/019970 A1

To manufacture a stator for an electrical machine, it is known to first manufacture a winding mat for forming the coil winding for the stator and then to insert it into a laminated core of the stator, as described and shown, for example, in document [9]. A winding mat is formed from several individual wires, in which straight wire sections, which are inserted in stator slots, are connected to each other by sections bent into a roof shape, the so-called winding heads. The individual wires are formed from a core of conductive metal, usually copper, and an outer insulating layer. To achieve a high filling level, the individual wires often have a mainly rectangular cross-section.

A manufacturing process known, for example, from document [8] for such coil windings formed from a winding mat is the so-called sword winding in which the individual wires are wound onto a former (sword), resulting in winding mats with spirally bent wires. Due to this manufacturing process, the winding heads include a twist. The wires are subject to strong deformation. Strong deformation can impair the insulation and increase the space required for the winding heads.

In contrast to sword winding, winding mats can also be manufactured from multiple flat-bent wave winding wires, as described and shown in documents [1] to [7]. As defined, in particular, in document [4], wave winding wires are single wires bent in a meander shape. The wave winding wires may be interlaced, interwoven, inserted, or stacked. Automated processes for interweaving or interlacing the bent wires to form a wave winding mat are known for this purpose.

Document [3] describes a method in which the bent wires are positioned to each other and then interwoven step by step by rotating the individual wires.

Document [2] discloses a method in which the conductors are bent over in sections so that a second conductor can be placed on top and a pair of conductors is formed by bending back the first conductor.

A method of inserting the winding wires is described in reference [4], in which two bent wave winding wires are positioned relative to each other so that they can be inserted into each other by arranging the wave winding wires in sections above or below the other wire in each case.

In document [5], among other things, a device is described in which a single wave winding wire is conveyed by an endless transport belt and then inserted in a further holder by raising and lowering guide rails.

In document [6], a wave winding mat produced by stacking is shown.

The invention is in the field of the manufacture of a wave winding mat from meander-shaped bent individual wires (=wave winding wires) for the manufacture of a coil winding of an electrical machine. The wave winding, which is usually prefabricated as a linear coil, can have different head configurations. The wire mat can now be made up of, for example, six wires with the same head or also with an additional interchange between two parallel conductors in the head, as shown for example in document [1], FIGS. 2 and 4. Also, a wire mat (=wave winding mat) can be composed of several differently bent wires with different geometry, see, e.g., document [2], FIG. 4.

Depending on the filling level and efficiency of the E-machine or generator, each wave winding mat can have its own stacking order of different individual wires, as this is described and shown, in particular, in document [7].

### SUMMARY OF THE INVENTION

It is an object of the invention to provide methods and devices with which different wave winding mats can be produced from wave winding wires in an automated and reliable manner.

According to one aspect, the invention provides a stacking method for stacking wave winding wires to form a winding mat for a coil winding of a stator, the stacking method comprising the steps of:
providing at least one magazine containing a plurality of similar wave winding wires in a receiving space, the magazine being designed as a drop magazine such that, with one directional component, the receiving space extends through the magazine in a vertical direction, wherein the contour of the receiving space is adapted to the received wave winding wires so that the wave winding wires are positioned at several guide devices at different locations of the boundary of the receiving space and are guided through the receiving space without changing their geometry,
positioning a workpiece carrier provided with a retaining structure for a winding mat formed of a plurality of stacked wave winding wires in a first transfer position below the at least one magazine, and depositing a wave winding wire from the at least one magazine at a first position on the workpiece carrier,
positioning the workpiece carrier in a second transfer position offset from the first transfer position below the at least one magazine, and depositing a further wave winding wire from the at least one magazine at a position offset from the first position on the workpiece carrier.

Preferably, the stacking method comprises:
providing a plurality of magazines, each containing different shaped wave winding wires with respective receiving spaces adapted thereto,
positioning the workpiece carrier at a first one of the magazines and depositing a first wave winding wire from the first magazine at the first position on the workpiece carrier; and
positioning the workpiece carrier at a second of the magazines and depositing a second wave winding wire from the second at the second position on the workpiece carrier.

It is preferred that the depositing comprises the step of:
separating the lowermost wave winding wire of the magazine to be deposited by means of a separating device which displaces the wave winding wire to be deposited from the receiving space to a depositing position, wherein the wave winding wire is held and/or guided during the displacement in such a way that its geometry is maintained.

It is preferred that the depositing comprises the step of:
feeding wave winding wires downwards to the receiving space in a vertical direction.

It is preferred that the depositing comprises the step of:
guiding the wave winding wires in the receiving space so that the geometry is maintained.

It is preferred that the depositing comprises the step of:
applying a vertical force to the wave winding wires arranged in the receiving space from above, so as to feed and/or position the wave winding wires in the receiving space in the vertical direction and/or press them against a support provided in the lower region.

It is preferred that the depositing comprises the step of:
using a slider movable transversely to the longitudinal direction of the wave winding wires as a support to prevent wave winding wires from falling out of the receiving space unintentionally, and/or as a separating device.

It is preferred that the depositing comprises the step of:
actively inserting the wave winding wire to be deposited into the retaining structures by inserting elements moved in the vertical direction.

It is preferred that the positioning comprises the step of:
positioning the retaining structure in a transverse direction which extends transversely to the longitudinal extension of the wave winding wires received in the receiving space, at a depositing position offset in the transverse direction relative to the receiving space.

It is preferred that the positioning comprises the step of:
positioning the workpiece carrier in the longitudinal direction extending in the direction of the longitudinal extension of the wave winding wires received in the receiving space, at a transfer position longitudinally offset relative to a previous transfer position.

It is preferred that the positioning comprises the step of:
positioning the workpiece carrier vertically at the transfer position such that the support structures vertically overlap with guide devices of the magazine.

According to a further aspect, the invention provides a manufacturing method for manufacturing a winding mat for a coil winding of a stator, the method comprising performing the stacking method according to one of the preceding embodiments (also in any combination with each other) to obtain a stack of wave winding wires, in which stack winding heads are arranged on both sides, and embossing the stack on the workpiece carrier in the region of the winding heads.

According to a further aspect, the invention provides a magazine for use in the stacking process according to any of the preceding embodiments, comprising:
a meander-shaped receiving space for a plurality of similar wave winding wires having lateral guide devices for accurately guiding and/or laterally positioning the wave winding wires without tension, the receiving space extending vertically through the magazine with at least one directional component;
a storage guide device for depositing a wave winding wire at a depositing position arranged relative to the receiving space in a transverse direction extending transversely to the longitudinal extension of the meander-shaped receiving space, and a positioning device for positioning a workpiece carrier having a retaining structure in the transverse direction and in a longitudinal direction.

It is preferred that the receiving space is formed by a boundary from a plurality of interchangeable segmented magazine parts.

Preferably, the magazine further comprises a separating device for laterally displacing the lowermost wave winding wire from the receiving space to the depositing position with guide devices for maintaining the geometry of the wave winding wire.

Preferably, the magazine further comprises a transversely reciprocating slider as a support for preventing the wave winding wires from falling downwardly from the receiving space and/or for separating the lowermost wave winding wire by laterally displacing it from the receiving space to the depositing position.

According to a further aspect, the invention provides a stacking device for performing the stacking method according to any of the preceding embodiments, the stacking device comprising:
at least one magazine according to any one of the preceding embodiments,
at least one workpiece carrier with a retaining structure for the stack of deposited wave winding wires,
at least one moving device for relatively moving the workpiece carrier and the at least one magazine, and
a control unit adapted to control the stacking device for automatically performing the stacking process according to any of the preceding embodiments.

Preferably, the stacking device comprises insertion elements for actively inserting the wave winding wire to be deposited into the retaining structure.

Preferably, the stacking device comprises a hold-down member for exerting a vertical force on the wave winding wires in the receiving space.

Preferably, the stacking device comprises a first magazine, configured according to one of the preceding embodiments, for receiving first wave winding wires, and a second magazine, preferably also configured according to one of the preceding embodiments, with a differently contoured receiving space for receiving second wave winding wires different from the first wave winding wires, wherein the movement device is designed to move the workpiece carrier between depositing positions of the first and second magazines—preferably, but not necessarily, with different displacement in the longitudinal direction.

In embodiments of the methods and the device according to the invention, the wave winding wires can also be stacked on top of each other in the same position on the workpiece carrier—in particular in the case of differently shaped wave winding wires.

According to a further aspect, the invention provides a control unit for a stacking device according to any one of the preceding embodiments, the control unit being adapted and configured to control the stacking device to perform the stacking process according to any one of the preceding embodiments.

According to a further aspect, the invention provides a computer program comprising control instructions for causing a stacking device according to any one of the preceding embodiments to perform the stacking method according to any one of the preceding embodiments.

According to a further aspect, the invention provides a manufacturing apparatus for manufacturing a winding mat for a coil winding of a stator, the manufacturing device comprising a stacking device according to one of the preceding embodiments and a press adapted to emboss, on the workpiece carrier, winding heads of a stack of wave winding wires formed on the workpiece carrier.

Preferred embodiments of the methods, devices and apparatuses according to the invention relate to or enable a true-to-shape and true-to-position transfer of a wave winding wire without intermediate handling.

Preferably, even very different wave winding mats, including those with conductor exchange as known from [1], with different bent wave winding wires as known from [2] and/or also with wave winding wires different with respect to cross-sections as known from [7], can be produced very gently by stacking in an automated manner. Preferably, deformations and twisting and other strong stresses on the individual wires are avoided, so that risks of damage are reduced.

A particular advantage of the embodiments according to the invention is that wires can be stacked into mats, ensuring that the wire that has already been bent into a wave shape reliably retains its shape and position during handling.

Embodiments of the invention make it possible to stack meander-shaped bent wires (=wave winding wires) on top of each other and to align them with each other. The stacking can take place in different ways, i.e., either individually on top of each other or as pre-grouped individual wires. The wave winding wires themselves can also have the same contour or, due to electrical advantages, different contours, which significantly complicates handling. The alignment with respect to each other is provided in order to be able to transfer the finished wave winding mat to a corresponding pick-up, e.g., a mandrel with narrow slots, see [9], and then insert it into a stator or rotor.

During the manufacture of a single wave winding wire, residual stresses are created which, similar to a spring, push the bent wire apart along its length. This change in the wire should be prevented or at least or reduced for a uniform winding mat. Otherwise, especially in the case of a particularly large number of layers, it is very difficult or possibly even impossible to automate the sorting of the wires again after stacking in accordance with the groove assignment scheme and to use them for subsequent processes, such as for forming or joining a winding head, as proposed, for example, in [9].

It should also be mentioned that although a stress-free production of a meander-shaped single wire is possible, it is connected with higher costs and therefore uneconomical, since the resilience varies due to material variations, and this could only be compensated on the process side by adjustable bending operations, but not with a low-cost bending system with fixed limit stops that is preferable for cost reasons.

In addition, each wave winding mat can have its own stacking sequence, which, as already mentioned, can be made up of several identical or several different individual wires or of a group of individual wires and should be adhered to exactly. Each wave winding wire can be different in its cross section, length and width, as well as in the bending of the roof (distances, head shape).

Preferred embodiments of the invention provide methods, devices and apparatus which enable the different wave winding wires to be assembled into a stacked mat in an automated and positionally accurate manner.

In preferred embodiments of the invention, in order to form a uniform wave winding mat, each individual meander-shaped bent wire (wave winding wire) is always maintained in a defined shape—preferably throughout the entire process. Some embodiments of the invention therefore describe a device in the form of a magazine, in particular a type of drop magazine, in which the wave winding wire is deposited along its contour in such a way that it cannot slip therein and cannot change its geometry. For the mat forming process, in some embodiments, a workpiece receiver—hereinafter referred to as workpiece carrier—is positioned and lifted out from under the device acting as a magazine. In some embodiments, the workpiece carrier is also constructed to hold the individual wires in place. In some embodiments, a positioning device is provided for relative positioning of the magazine and the workpiece carrier. In some embodiments, the workpiece carrier dives into the magazine, in particular drop magazine, to provide for an interlocking of the contours that allows the wire to be transferred in a defined manner without intermediate handling.

In some embodiments, any 2D shape of wire (width, length, height, head spacing, head shape) can be stacked by magazine parts segmented several times. Of course, the parts—especially the entire magazine housing—can also be made from one piece. Each wave winding wire is always held in shape by interaction of the individual magazine parts at several locations.

In some embodiments, in the case of the workpiece carrier already described, the lower part, which can also be segmented several times or made from one piece, retains the wire in a defined shape by means of simple bolts. This modular design has the advantage that a change in the geometry of the wave winding wire/mat can be quickly and easily converted.

In other known methods (such as the method known from [5]), the wave-shaped individual wires must have a height offset before a coil mat can be stacked. In this process, a single wave winding wire is formed by an embossing device at the winding heads and then conveyed to a loading station by means of an endless conveyor belt and guide rails. Only in the loading station the wire is positioned in the correct position in the workpiece carrier by raising and lowering the guide rails. In preferred embodiments of the invention, several individual mats can be placed on top of each other without any intermediate handling and stacked to form a mat. Any intermediate bending of the individual wires, which is also required in braiding for example (see e.g. [2]), can be omitted in embodiments of the invention, and the actuator system for depositing the individual wires in the pick-up can be of more simple design.

### BRIEF DESCRIPTION OF THE DRAWINGS

Embodiments of the invention are explained in more detail below with reference to the accompanying drawings. In the drawings it is shown by:

FIG. 1 is a schematic top view of an embodiment of a magazine for wave winding wires for use in a stacking process for stacking the wave winding wires to form a wave winding mat;

FIG. 2 is a schematic side view of a stacking device comprising such a magazine according to one embodiment;

FIG. 3 is a perspective view, partly broken away, of the stacking device, a start of a stacking process being shown;

FIG. 4 is a view comparable to FIG. 4, in a further step of the stacking process following the step shown in FIG. 3;

FIG. 5 is a top view of a slider used in the magazine with a wave winding wire;

FIG. 6 is a first perspective view of the slider, showing force introduction points between the slider and a wave winding wire to be separated by the slider;

FIG. 7 is a second perspective view of the slider;

FIG. 8 is a section through a front portion of the slider;

FIGS. 9a to 9h are schematic side views of the stacking device during successive steps of a preferred embodiment of a stacking process;

FIGS. 10a to 10h are perspective views, partly broken away, of the stacking device during the steps according to FIGS. 9a to 9h;

FIG. 11 is a schematic side view of a further embodiment of the stacking device;

FIG. 12 is a front view of a workpiece carrier of the stacking device with a wave winding mat stacked thereon in accordance with the stacking method;

FIG. 13 is a schematic side view of a manufacturing device for the wave winding mat including such a stacking device; and

FIGS. 14a to 14c are top views of one embodiment of the workpiece carrier at different stages of the stacking process.

### DETAILED DESCRIPTION OF THE PREFERRED EMBODIMENTS

Preferred embodiments of a stacking method for stacking wave winding wires 10 to form a winding mat 12 for a coil winding of a stator, as well as a magazine 14 usable in such a stacking method and a stacking device 16 provided with such a magazine 14 will be explained in more detail in the following with reference to the accompanying drawings.

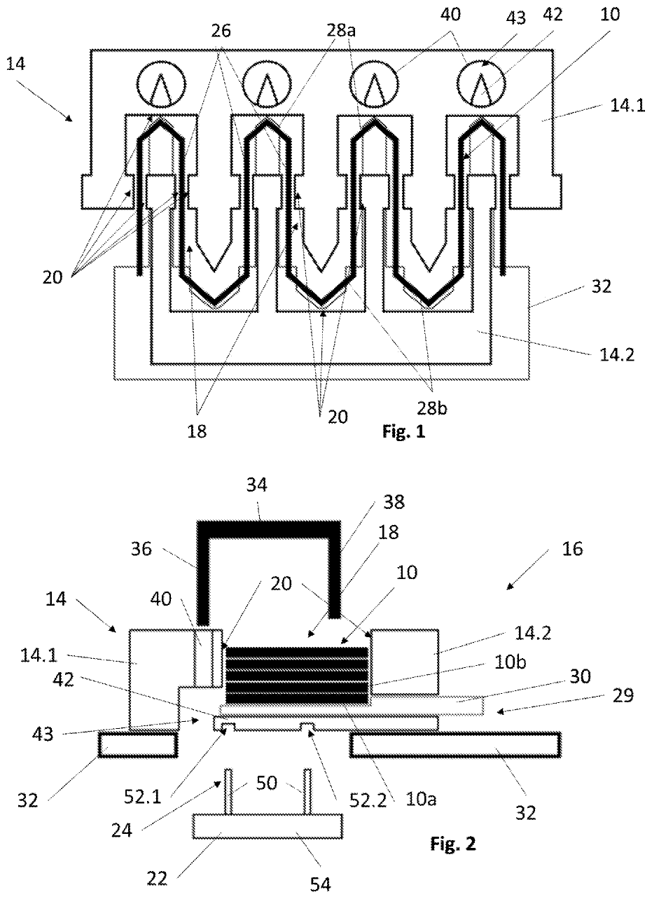

One embodiment of the magazine 14 alone is shown in FIG. 1, whereas the FIGS. 2 to 4 and 9a to 11 show the magazine as part of the stacking device 16.

In a simple embodiment, the stacking method first comprises the step of:
providing the at least one magazine 14 containing a plurality of similar wave winding wires 10 in a receiving space 18.

The magazine 14 is configured as a drop magazine, such that with at least one directional component, the receiving space 18 extends through the magazine 14 in a vertical direction. The contour of the receiving space 18 is adapted to the received wave winding wires 10, so that the wave winding wires 10 are positioned at a plurality of guide devices 20 at different locations of the boundary of the receiving space 18 and are guided through the receiving space 18 without changing their geometry.

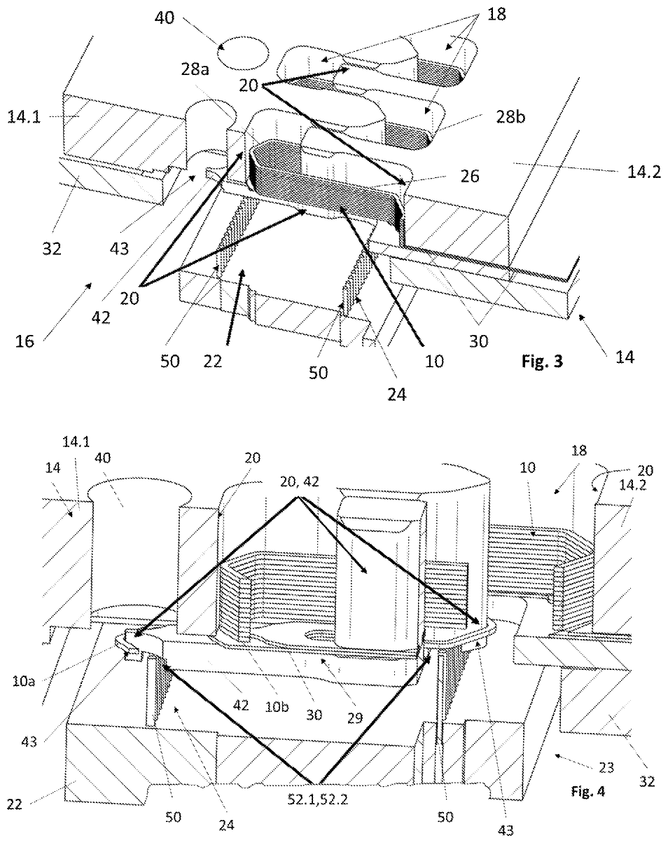

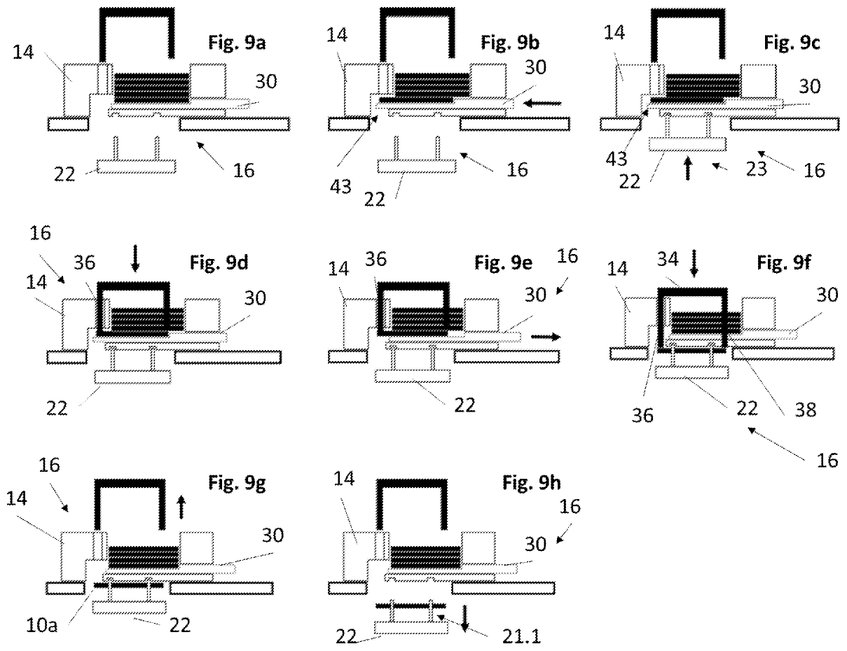

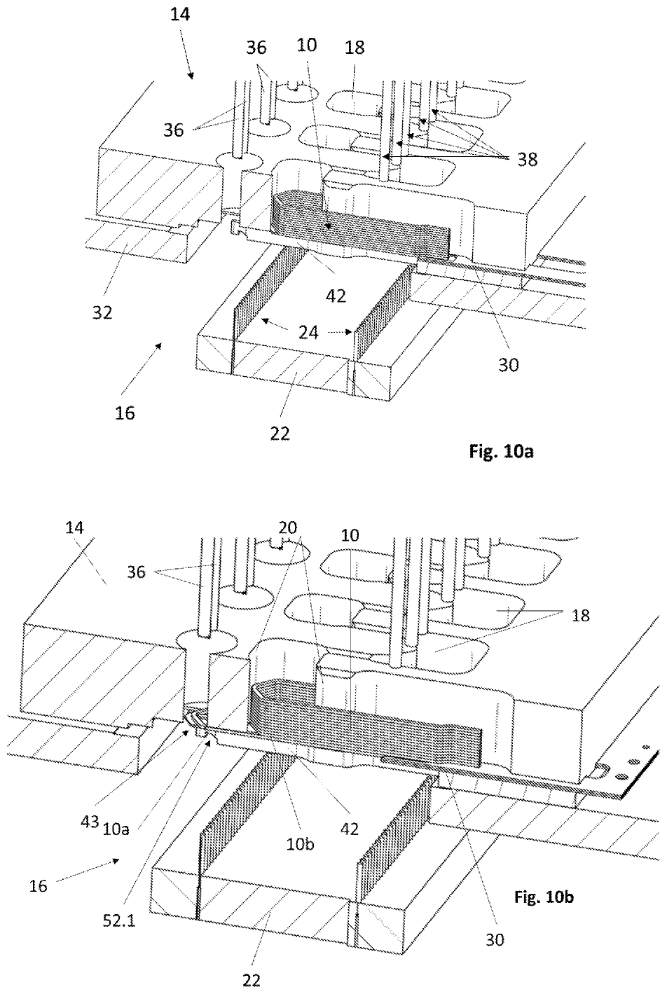

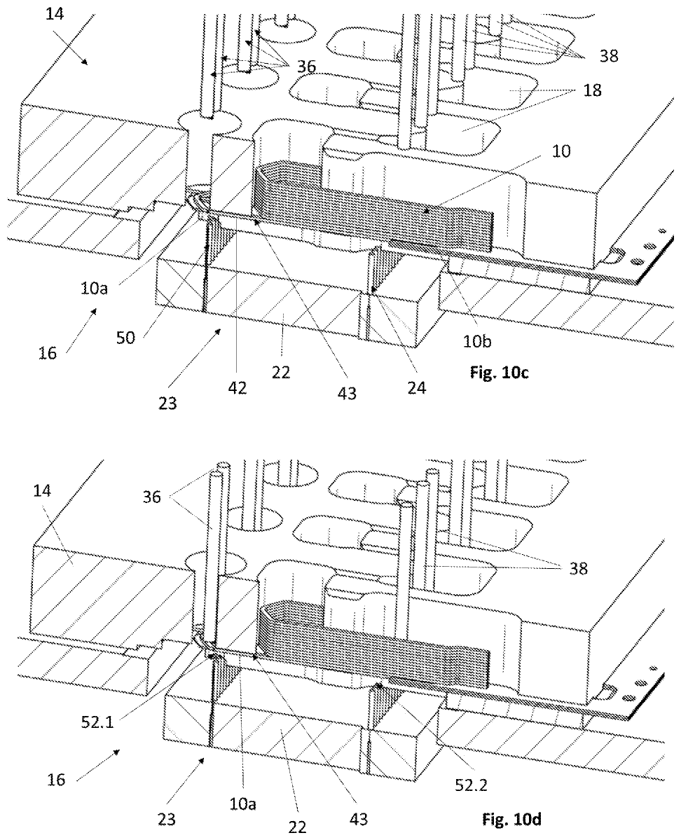

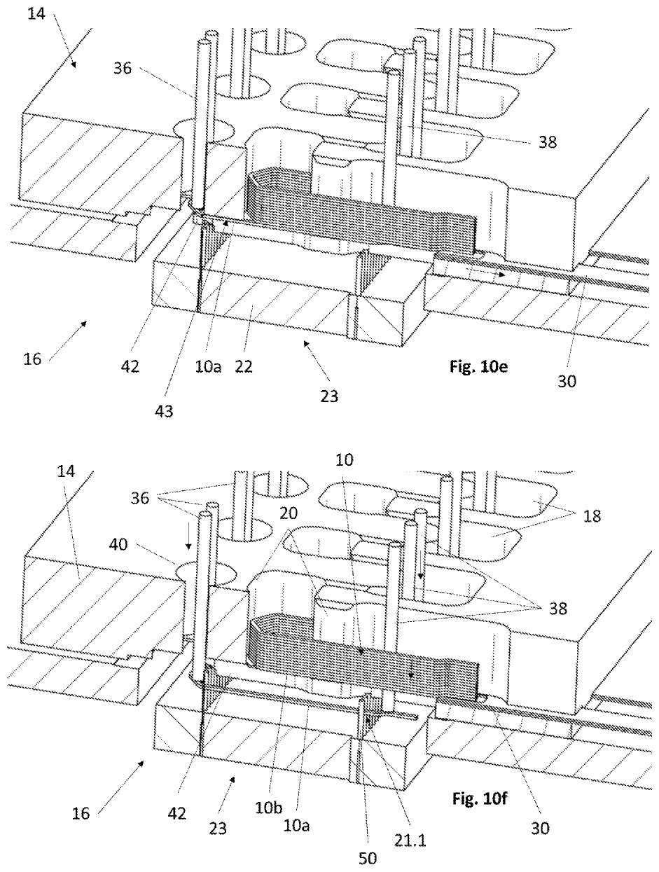

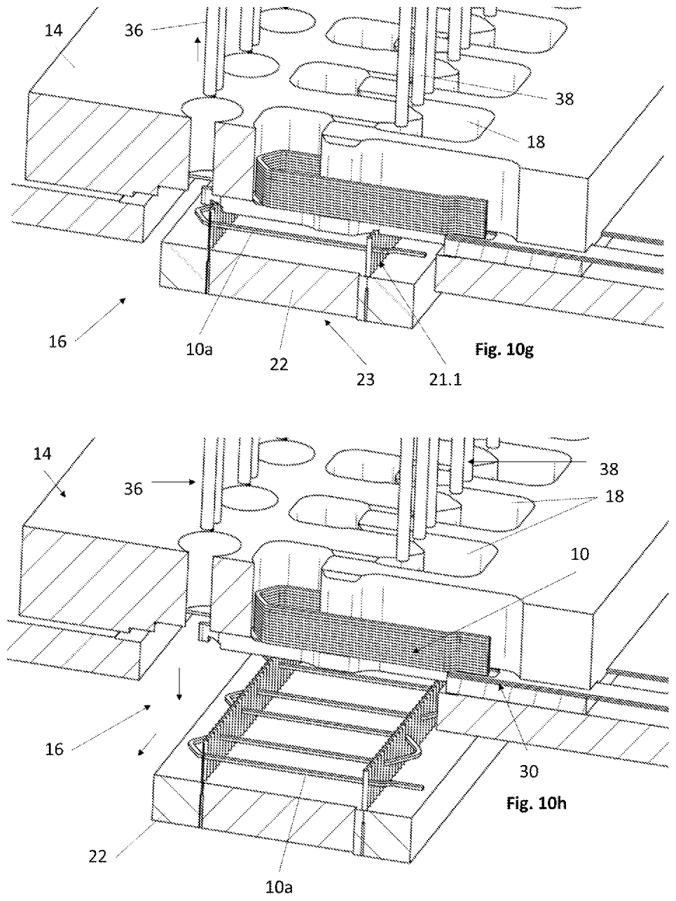

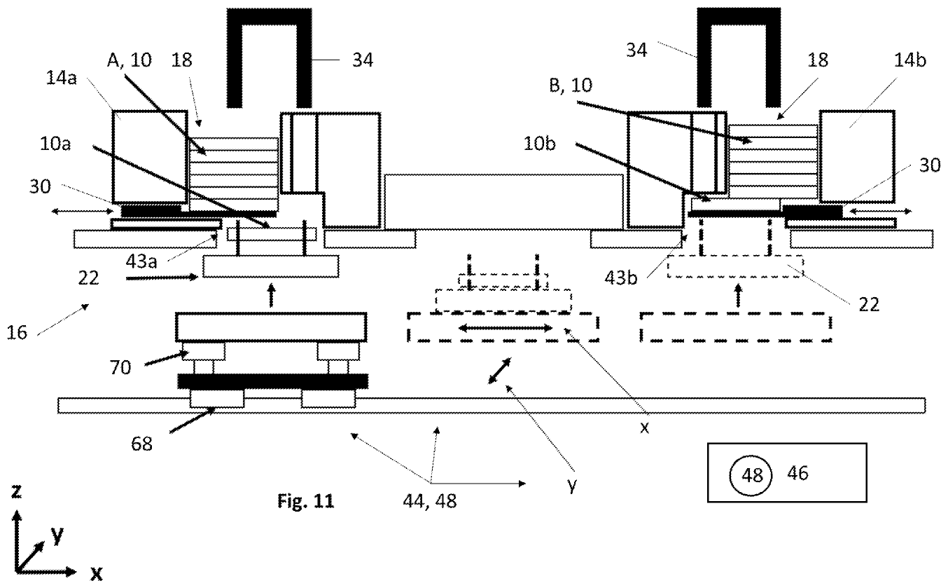

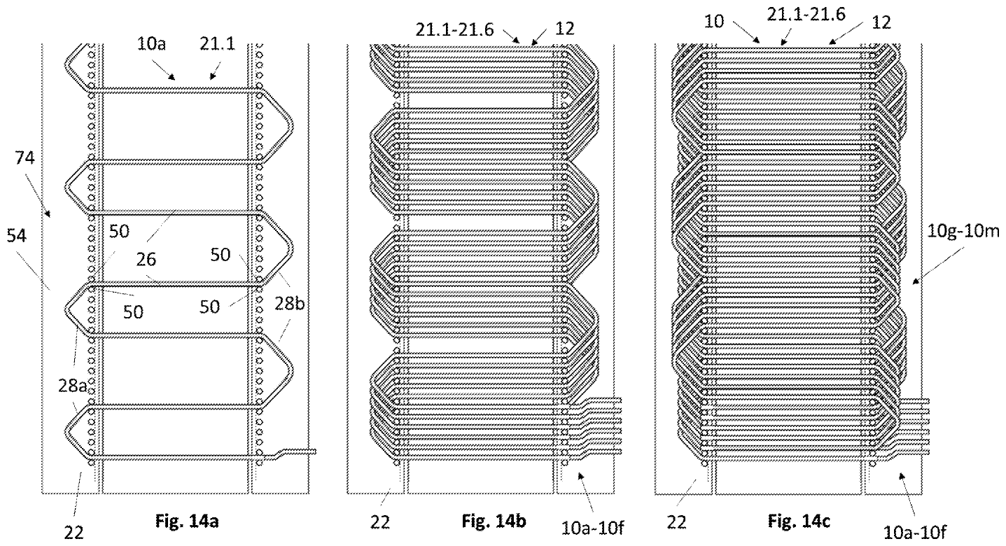

Further, the stacking method comprises the step of: positioning a workpiece carrier 22 provided with a retaining structure 24 for a winding mat 12 formed of a plurality of stacked wave winding wires 10 at a first transfer position 23 below the at least one magazine 14 and depositing a wave winding wire 10 from the at least one magazine 14 at a first position 21.1 on the workpiece carrier 22. One embodiment of the workpiece carrier 22 as part of the stacking device 16 is shown, for example, in FIGS. 2 to 4 and 9a-10h, wherein FIGS. 3 and 4 show the step of positioning at the first transfer position 23 and FIGS. 9f and 10f, for example, show one embodiment for the step of depositing. FIG. 14a shows one example of the first position 21.1 where a first wave winding wire 10a is deposited on the workpiece carrier 22.

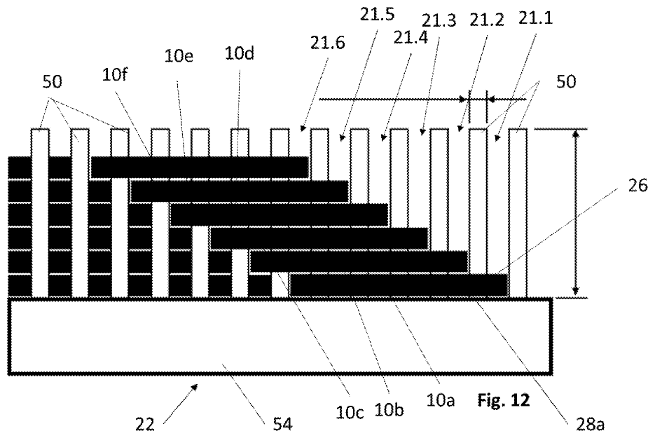

Further, the stacking method comprises the step of: positioning the workpiece carrier 22 at a second transfer position offset from the first transfer position 23 below the at least one magazine 14 and depositing another wave winding wire 10 from the at least one magazine 14 on the workpiece carrier 22 at a position 21.2, 21.3, 21.4, . . . offset from the first position 21.1. Examples of correspondingly offset wave winding wires 10a-10f deposited on the workpiece carrier 22 and a winding mat 12 formed therefrom are shown in FIGS. 12 and 14b and 14c. In particular, FIGS. 14b and 14c show the further positions 21.2, 21.2, 21.3, . . . of further wave winding wires 10b-10f offset from the first position 21.1 of the first wave winding wire 10a. In some embodiments, more than one wave winding wire may also be deposited at a common position on the workpiece carrier 22.

The stacking method can be performed using different magazines 14 and workpiece carriers 22, as long as they can perform the above functions.

Preferred embodiments of such magazines 14, workpiece carriers 22, stacking devices 16, as well as preferred embodiments of the stacking method and applications thereof are explained in more detail below with reference to the accompanying drawings.

FIG. 1 shows a top view of one embodiment of the magazine 14. The magazine 14 has a first magazine part 14.1 and a second magazine part 14.2, which are provided with projections and recesses so that they engage into one another and form the meander-shaped receiving space 18 between them. The magazine parts 14.1, 14.2 are formed as a single piece in some embodiments and from a plurality of interchangeable segments in other embodiments. If a set of different segments is provided, a magazine 14 adapted to one of several different wave winding wires 10 can be formed these segments.

As shown in FIG. 1 and FIGS. 2 and 3, which illustrate the magazine 14 together with other units or devices of the stacking device 16, a plurality of identical wave winding wires 10 are arranged one above the other in the receiving space 18.

The wave winding wires 10 are wave-shaped or meander-shaped and have a plurality of straight wire sections 26 arranged parallel to each other with a certain spacing therebetween and connected to each other by roof-shaped winding heads 28a, 28b.

Guide devices 20 are formed on the vertical boundary walls of the magazine parts 14.1, 14.2, which engage the straight wire sections 26 as well as each winding head 28a, 28b in order to guide the wave winding wires 10 from top to bottom through the receiving space 18 while maintaining their shape and position.

In preferred embodiments, the magazine 14 further comprises a separating device 29 for separating the wave winding wires 10 to be deposited.

For example, as shown in FIGS. 2 and 3, the magazine 14 comprises a slider 30 as part of the separating device 29 below the receiving space 18, the slider 30 being movable in the transverse direction—transversely to the longitudinal extension of the wave winding wires 10 and in the direction of the extension of the straight wire sections.

The magazine parts 14.1, 14.2 are mounted on a base 32. The magazine 14 further comprises a lift assembly 34 movable up and down relative to the base 32 and having front and rear pins 36, 38. Through holes 40 are provided in one of the magazine parts 14.1 for the front pins 36 to pass through. The rear pins 38 can be guided through the receiving space 18.

Below the slider 30, the magazine 14 further comprises a storage guide device 42 for depositing a wave winding wire 10 at a depositing position 43 which is offset from the receiving space 18 in the transverse direction. The storage guide device 42 is, for example, plate-like in design and also has a meandering contour adapted to the shape of the wave winding wire 10, which serves to guide a wave winding wire 10 offset from the receiving space 18 to the depositing position 43 when it is deposited on the workpiece carrier 22. In particular, when the magazine 14 is constructed in segments, the storage guide device 42 can also be selected from an assortment of different storage guide devices or constructed from an assortment of different segments to form the storage guide device 42.

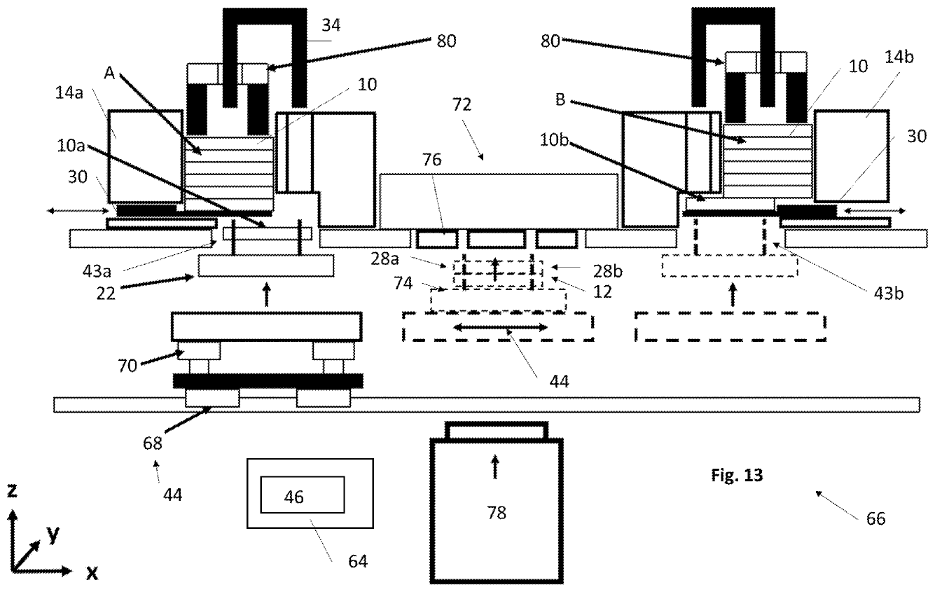

Below the magazine 14, the stacking device 16 has the workpiece carrier 22 serving as a workpiece receiver, which is movable relative to the magazine 14 upward and downward (in the z-direction) and in the longitudinal extension direction of the wave winding wires 10 or of the receiving space 18 (in the y-direction) by means of a movement device 44 explained in more detail later with reference to FIGS. 11 and 13. The movement device 44 has a positioning device 48, for example configured as part of a control unit 46, by means of which the workpiece carrier 22 can be positioned in the longitudinal direction (y-direction; corresponds to the longitudinal direction of the receiving space 18 and the wave winding wires received therein) at a plurality of predefined transfer positions 23 relative to the magazine 14. In the transverse (x-direction), the workpiece carrier 22 is positioned for stacking below the depositing position 43.

In order to form a uniform wave winding mat or, in short, winding mat 12 by stacking, each individual wire bent in a meandering shape—wave winding wire 10—is always retained in a defined shape throughout the stacking process. The magazine 14 is designed as a kind of drop magazine in which the wave winding wire 10 is deposited along its contour in such a way that it cannot slip in it (in the transverse or longitudinal direction) and cannot change its geometry. For the mat-forming process, the workpiece carrier 22 is positioned and lifted out from under the magazine 14 by means of the positioning device 48. The workpiece carrier 22 is also designed to retain the individual wires in their shape. By the workpiece carrier 22 diving into the magazine 14, an interlocking of the contours is created, which makes it possible to transfer the wave winding wire 10 in a defined manner and without intermediate handling.

As shown in FIGS. 2 and 3, the retaining structure 24 of the workpiece carrier 22 has a plurality (two in this case) of rows of guide pins or locating pins arranged in a comb-like manner.

The magazine has receiving recesses 52.1, 52.2 on its underside, in particular on the underside of the storage guide device 42, into which the locating pins 50 of the retaining structure 24 of the workpiece carrier 22 diving into the magazine can be received in order to transfer a wave winding wire 10. In the state dived into the magazine, as shown in FIG. 4, when viewed in the z-direction, the locating pins 50 intersect with the guide devices 20, 42 of the magazine 14. The wave winding wire 10 is seamlessly guided and without intermediate handling during the transfer while maintaining its shape and position.

In some embodiments, multiple segmented magazine parts 14.1, 14.2, 30, 42 can be used to stack any 2D shape of wire (width, length, height, head spacing, head shape). Of course, the parts 14.1, 14.2, 30, 42 can also be made of one piece. Each wave winding wire 10 is always maintained in its shape by the interaction of the individual magazine parts 14.1, 14.2, 30, 42 at several points. In the case of the workpiece carrier 22 already described, a lower part 54, which can also be segmented several times or made from one piece, retains the transferred wave winding wire 10 in a defined shape with the aid of simple pins—here the locating pins 50. The optional modular design has the advantage that a change in geometry of the wave winding wire 10 and/or the winding mat 12 formed with it can be quickly and easily converted.

In the stacking process as well as the stacking device 16 according to preferred embodiments of the invention, single wires or even several single mats (groups of several wave winding wires 10) can be placed on top of each other without any intermediate handling and stacked to form a winding mat 12. Intermediate bending of the individual wires can be eliminated and the actuator system for depositing the individual wires in the workpiece carrier 22 can be configured much simpler than before.

Several 2D-bent (bent two-dimensionally in one plane) wave winding wires 10 are placed one above the other in the magazine 14, which is specially adapted for their wire geometry. By adapting the magazine 14, the stacking device 16 can accommodate almost all widths, lengths and heights of the individual wire. Even straight sections of different lengths, as well as different roof geometries (size, in particular length in longitudinal direction or other geometry of the winding heads) within a wave winding wire 10 are no longer important.

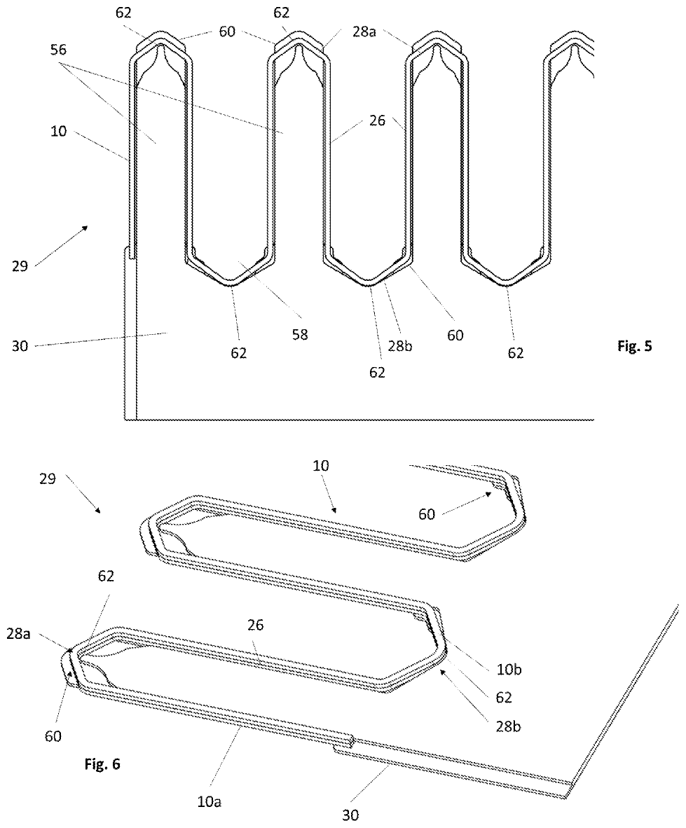

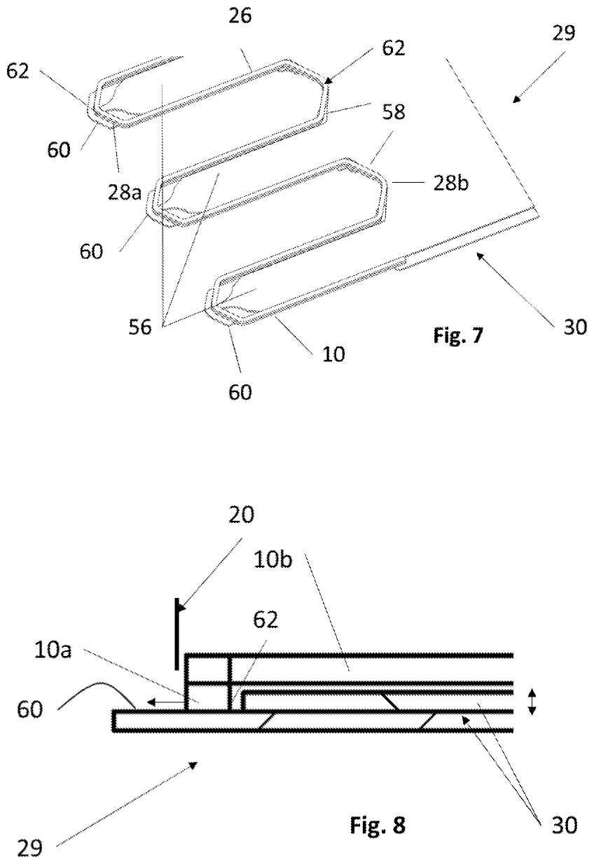

At the bottom of the magazine 14 the slider 30 is located, an embodiment of which is shown in FIGS. 5 to 8 and which preferably also has a shape specially adapted to the wave winding wire 10.

In some embodiments, the slider 30 performs at least two functions. First, it serves as a support, preventing the wave winding wire 10 from falling down unintentionally. Second, it is used to separate the wave winding wires 10. In other embodiments, the slider 30 may also be configured such that the wave winding wire 10 is not deposited thereon, in which case the slider 30 serves only for separation. This is possible, for example, in that the wave winding wire 10 presses itself outwardly against the guide devices 20 of the magazine 14 due to the inherent tension of the meandering bend. For an improved process with regard to process reliability, however, as in the embodiments shown, the slider 30 is preferably also designed as a support for the wave winding wire 10 as described.

According to FIGS. 5 to 8, the slider 30 has tooth-like projections 56 adapted to the meander shape with recesses 58 therebetween and step-like wire supports 60 formed thereon to form force application points 62. In order to uniformly separate the wave winding wire 10, the force for displacement is introduced at each bend of the roof, at the front (at the respective front winding head 28a) as well as at the rear (at the respective rear winding head 28b). As indicated in FIGS. 5 and 6, this can take place at only one point per roof (winding head 28a, 28b), but also at several points of the wave winding wire 10.

Depending on the wire height, different sliders 30 can be used in the manufacturing process for the winding mat 12. In the case of higher wave winding wires 10, the slider 30 can, for example, be made from a single part, e.g., from a solid plate by machining or other suitable processes. However, in the case of lower wave winding wires 10, for example, two sheets of thin material thickness can also be joined together, preferably welded, so that together they are smaller in height than one wave winding wire. An example of a slider 30 formed from two interconnected individual parts, such as lasered sheets, is shown in vertical section in FIG. 8.

In the embodiments shown, the height (z-direction) of the slider 30 is such that only the lowest wave winding wire 10 is displaced in the magazine. The other superimposed wave winding wires 10 are then retained by the magazine during separation.

In the following, a particularly preferred embodiment of the stacking process (with some advantageous optionally provided steps) is explained in more detail on the basis of the illustrations of FIGS. 9a to 9h, which each show schematic side views of the stacking device 16 at different steps, and of FIGS. 10a to 10h, which show perspective views, partly broken away, of the stacking device 16 at the corresponding steps.

The sequence of the stacking process is controlled by the control unit 46 (indicated in FIGS. 11 and 13) of the stacking device 16, which may be part of an overall control system 64 of a manufacturing device 66 for the winding mat 12. The control units 46, 64 are designed, in particular, as electronic control units with computer programs loaded therein and contain corresponding instructions for controlling the movement sequences of the devices 16, 66.

In advantageous embodiments of the stacking method, a workpiece carrier 22 is positioned below the magazine 14 and then lifted out. Depending on the wire and mat geometry, the workpiece carrier 22 itself has locating pins 50 which are arranged and designed in a corresponding manner. A wire section is always located between two adjacent locating pins 50—in particular, the straight wire sections 26 are each deposited between two adjacent locating pins 50.

The spacing between the locating pins 50 is selected to correspond to the spacing of the grooves in the component of the electrical machine receiving the coil winding—in particular the laminated core of a stator. When the winding mat 12 is used in the stator, its longitudinal direction (y-direction of the accompanying Figures) corresponds to the circumferential direction in the stator, the height direction (z-direction) of the winding mat 12 corresponds to the radial direction when used in the stator, and the transverse direction (x-direction) corresponds to the axial direction when the winding mat 12 is used in the stator.

According to FIG. 4, to which reference is now again made, the diving of the locating pins 50 of the workpiece carrier 22 positioned in the transfer position 23 into the magazine 14 creates a transfer zone which enables the individual wave winding wire 10 to be stably retained in its shape over the whole time. To ensure that each wave winding wire enters the workpiece carrier 22 in a better controlled manner, in the embodiment shown it is actively pushed into the workpiece carrier 22 during transfer, preferably by means of simple pins—in this case the front and rear pins 36, 38. This improves the process reliability, and each wave winding wire 10 enters the workpiece carrier 22. This active pushing can take place, for example, at two or more points per winding head 28a, 28b, but also at only one point per winding head 28a, 28b. According to preferred embodiments, the front pins 36 have the additional task of retaining the wave winding wire 10 at the separated, front position—i.e., the depositing position. For example, the front pins as separating pins can be provided with a simple step so that the wave winding wire 10 is not pulled along backwards when the slider 30 is retracted.

FIGS. 9a and 10a show the initial position in the preferred embodiment of the stacking method. A plurality of wave winding wires 10 are provided in the magazine 14 in the receiving space 18. The lowermost wave winding wire 10a rests on the retracted slider 30 (or, in other embodiments, on the storage guide device 42).

According to FIGS. 9b and 10b, the slider 30 then separates the lowermost wave winding wire 10a. For this purpose, the slider 30 is moved from an initial position below the receiving space 18 in the transverse direction to the depositing position 43 while entraining the lowermost wave winding wire 10a.

According to FIGS. 9c and 10c, the workpiece carrier 22 is positioned at a first transfer position 23 corresponding to a first position 21.1, which the wave winding wire to be deposited—in this case initially the lowermost wave winding wire 10a—has to assume in the longitudinal direction on the workpiece carrier 22 and ultimately within the winding mat 12 (see FIGS. 14a-14c). For this purpose, the winding carrier 22 initially assumes the longitudinal position shown in FIGS. 10b to 10g for the first wave winding wire 10a. The workpiece carrier 22 is lifted out—as shown in FIGS. 9c and 10c—in particular after positioning in the longitudinal direction. For this purpose, the workpiece carrier 22 and the magazine 14 are moved relative to each other in the vertical direction (z-direction) towards each other until the workpiece carrier 22 dives into the magazine 14 and the locating pins 50 and the guide devices 20 overlap each other in the vertical direction.

According to FIGS. 9d and 10d, the pins 36, 38 then move into a retaining position in which they secure the wave winding wire—here, for example, the first wave winding wire 10a-that has been shifted to the depositing position and thus separated to be deposited, against a movement back in the transverse direction. For this purpose, the lifting arrangement 34 moves downward with the front and rear pins 36, 38 until the step-like ends engage the front winding heads 28a of the wave winding wire 10a to be deposited.

According to FIGS. 9e and 10e, the slider 30 then moves back to its initial position, clearing the way for the wave winding wire 10a to be deposited.

According to FIGS. 9f and 10f, the front and rear pins 36, 38 then push the wave winding wire 10a to be deposited into the workpiece carrier 22—in particular while being guided by the storage guide device 42. Here, the straight wire sections 26 of the wave winding wire 10a to be deposited are each received between several pairs of adjacent locating pins 50.

According to FIGS. 9g and 10g, the pins 36, 38 then move back to their initial position. For this purpose, the lifting arrangement 34 moves upward with the front and rear pins 36, 38.

According to FIGS. 9h and 10h, the workpiece carrier 22 then moves back to its starting position with the wave winding wire 10a placed on it.

Subsequently, the workpiece carrier 22 is repositioned in its longitudinal direction according to the desired second position 21.2 of the next wave winding wire 10b to be deposited. For this purpose, the workpiece carrier 22 is generally positioned relative to the magazine 14 at a second transfer position offset longitudinally with respect to the first transfer position 23, in order to deposit a further wave winding wire 10b offset with respect to the previously deposited wave winding wire 10a on the workpiece carrier 22 with the steps that are otherwise the same as described for the first wave winding wire 10a. However, depending on the design of the winding mat 12, it is also possible for another wave winding wire 10b to be deposited at the same longitudinal position as a wave winding wire 10a that has been deposited directly or indirectly before.

FIGS. 12 and 14a-14c show different views of the workpiece carrier 22 with exemplary wire stacks.

According to some embodiments, as has been illustrated with reference to FIGS. 1 to 10, the stacking device 16 may comprise a single magazine 14 for stacking a winding mat 12 of similar wave winding wires 10.

In FIG. 11, a further embodiment of the stacking device 16 is shown comprising a plurality of such magazines 14, for example at least a first magazine 14a and a second magazine 14b. The movement device 44 is designed to position the workpiece carrier 22, for example by moving it in the transverse direction (x-direction), selectively at the depositing position 43a of the first magazine 14a or at the depositing position 43b of the second magazine 14b.

Since, as already described, a winding mat 12 can also be composed of differently bent single wires—wave winding wires 10—preferably at least one magazine 14a, 14b is provided for each different single wire geometry to be used, depending on the mat geometry, in particular the number of different single wires, the quantity of single wires used in each case and/or the stacking order of the single wires. In the first magazine 14a, a first stack A of wave winding wires 10 with a first geometry is arranged, and in the second magazine 14b, a second stack B with wave winding wires 10 with a different second geometry is arranged.

In order to map the stacking sequence in the workpiece carrier 22, the latter is preferably moved back and forth between the magazines 14a, 14b (movement in the transverse direction or x-direction) via first linear axes 68—example of actuators of the movement device 44. During travel, the workpiece carrier 22 can be moved perpendicular to the direction of travel, i.e., here in the longitudinal direction or y-direction, also preferably using linear axes, in this case the second linear axes 70, in order to produce the required distance between each individual wire with repeatable accuracy and uniformity. Thus the positioning in the longitudinal direction from the first transfer position 23 to the second transfer position can already take place during the travel between the magazines 14a, 14b.

FIG. 11 also shows the control unit 46 already mentioned above, which is connected to the actuators of the stacking device 16, such as, in particular, the actuators for the stroke of the lifting arrangement 34, the actuators of the slider 30 and the actuators of the movement device 44 (for movement of the workpiece carrier 22 in the x-, y- and/or z-directions), and is designed to control the stacking device 16 for automatically carrying out the stacking process.

FIG. 13 shows a manufacturing device 66 for manufacturing the winding mat 12 for forming a coil winding for a stator (or for a rotor). The manufacturing device 66 comprises the stacking device 16 according to one of the previously explained embodiments (here, for example, with first and second magazines 14a, 14b) and a press 72 adapted to emboss winding heads 28a, 28b of a stack of wave winding wires 10 formed on the workpiece carrier 22.

For example, the press 72 includes a lower embossing die 74, an upper embossing die 76, and a joining module 78. Preferably, the lower part 54 of the workpiece carrier 22 is formed as a lower part of the embossing die 74 or is disposed on the lower embossing die 74.

Further, the manufacturing device 66 includes the overall control system 64 configured to automatically control the manufacturing device 66 to perform the manufacturing process for manufacturing the winding mat 12. In addition to performing the stacking process, the manufacturing process also includes embossing winding heads 28a, 28b of the wave winding wires 10a-10f already stacked on the workpiece carrier 22.

A finished winding mat 12 thus is comprised not only of individual wires placed one on top of the other. In order to optimally fit the winding mat 12 into a rotor or stator laminated core, the wave winding wires 10, 10a-10f rather have an embossing in the head area. In order to obtain this, in preferred embodiments, the workpiece carrier 22 is designed in such a way that the individual wires are immediately stacked on the lower part 54 of an embossing die 74. By means of the preferably used linear units 68, 70, the workpiece carrier 22 can be moved exactly to the appropriate upper embossing die 76. This makes it possible, regardless of how many wave winding wires 10 are in the workpiece carrier 22, to then press the winding mat 12—in several partial steps or as a whole. A joining module 78 used for this purpose can perform the pressing from below but also from above. An additional advantage is that even after the pressing process, the winding mat 12 is still retained in shape by the locating pins 50. This makes further workpiece transfer much easier.

As shown in the example of FIG. 13, in some embodiments, the magazine 14 can additionally be equipped with a hold-down device 80, which provides additional safety for separating only the lowest wave winding wire 10 in the magazine. The hold-down device 80 allows any unevenness to be removed by pressing, and the wave winding wires 10, 10a-10g lie flat on the slider 30 (or the depositing guide device 32). The hold-down device 80 can be moved, for example, by means of an actuator controlled by the control unit 46 to apply a vertical hold-down force from above to the wave winding wires arranged in the receiving space 18 of the magazine 14.

FIG. 14a shows the workpiece carrier 22 with the first wave winding wire 10a placed thereon at the first position 21.1. FIG. 14b shows the workpiece carrier 22 with a winding mat 12 comprising a first to sixth wave winding wire 10a-10f stacked on top of each other at different positions 21.1-21.6. FIG. 14c shows a winding mat 12 in which a seventh to twelfth wave winding wire 10g-10m are further stacked on the first to sixth wave winding wires 10a-10f. As shown in FIG. 14c, a plurality of wave winding wires 10a, 10g may also be stacked at the same position 21.1 in the longitudinal direction. The second and eighth wave winding wires 10b, 10h are stacked on top of each other at the second position 21.2, and so on.

The systems and devices described herein may include a controller, control unit, controlling means, system control, processor or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 wave winding wire
10a first wave winding wire
10b second wave winding wire
10c third wave winding wire
10d fourth wave winding wire
10e fifth wave winding wire
10f sixth wave winding wire
10g-10m seventh to twelfth wave winding wires
12 winding mat
14 magazine
14a first magazine
14b second magazine
14.1 first magazine part
14.2 second magazine part
16 stacking device
18 receiving space
20 guide device
21.1 first position
21.2, 21.2, 21.3, . . . further positions
22 workpiece carrier
23 transfer position
24 retaining structure
26 straight wire section
28a first winding head
28b second winding head
29 separating device
30 slider
32 base
34 lifting arrangement
36 front pins
38 rear pins
40 through hole
42 storage guide device
43 depositing position
43a depositing position (first magazine)
43b depositing position (second magazine)
44 movement device
46 control unit
48 positioning device
50 locating pin
52.1 front receiving recess
52.2 rear receiving recess
54 lower part
56 tooth-like projection (of the slider)
58 recess (of the slider)
60 wire support
62 force application point
64 overall control system
66 manufacturing device
68 first linear axis
70 second linear axis
72 press
74 embossing die (lower part)
76 upper embossing die
78 joining module
80 hold-down device
A first stack
B second stack

1. A stacking method for stacking wave winding wires to form a winding mat for a coil winding of a stator, said stacking method comprising the steps of:
providing at least one magazine containing a plurality of similar wave winding wires in a receiving space,
wherein the magazine is configured as a drop magazine such that the receiving space extends, with at least one directional component, in a vertical direction through the magazine,
wherein a contour of the receiving space is configured to received wave winding wires, so that the wave winding wires are positioned at a plurality of guide devices at different locations of a boundary of the receiving space and are guided through the receiving space without changing their geometry,
positioning a workpiece carrier which is provided with a retaining structure for the winding mat formed of a plurality of stacked wave winding wires in a first transfer position below the at least one magazine and depositing a wave winding wire from the at least one magazine at a first position on the workpiece carrier,
positioning the workpiece carrier in a second transfer position offset relative to the first transfer position below the at least one magazine, and depositing a further wave winding wire from the at least one magazine at a position offset relative to the first position on the workpiece carrier.

2. The stacking method according to claim 1, further comprising:
providing a plurality of the at least one magazine, each containing different shaped wave winding wires with respective receiving spaces adapted thereto,
positioning the workpiece carrier at a first one of the magazines and depositing a first wave winding wire from the first magazine at the first position on the workpiece carrier, and
positioning the workpiece carrier at a second position being at a second of the magazines and depositing a second wave winding wire from the second magazine at the second position on the workpiece carrier.

3. The stacking method according to claim 1, wherein the depositing comprises at least one or more of the steps:
separating a lowermost wave winding wire to be deposited of the magazine by means of a separating device which causes a displacement of the wave winding wire to be deposited from the receiving space to a depositing position, wherein the wave winding wire is at least one of retained or guided during the displacement in such a way that a geometry of the wave winding wire is maintained;
feeding of wave winding wires in the receiving space in a vertical downward direction;
guiding the wave winding wires in the receiving space so that their geometry is maintained;
applying a vertical force to the wave winding wires arranged in the receiving space from above in order to at least one of
guide the wave winding wires,
position the wave winding wires in the receiving space in the vertical direction, or
press the wave winding wires against a support provided in a lower region;
using a slider, which is displaceable transversely to a longitudinal direction of the wave winding wires, at least one of
as a support to prevent wave winding wires from falling out of the receiving space unintentionally, or
as a separating device; or
active insertion of the wave winding wire to be deposited into the retaining structures via insertion elements moved in the vertical direction.

4. The stacking method according to claim 1, wherein the positioning comprises at least one or more of the steps:
positioning the retaining structure in a transverse direction which extends transversely to a longitudinal extension of the wave winding wires received in the receiving space at a depositing position offset in the transverse direction relative to the receiving space;
positioning the workpiece carrier in a longitudinal direction which extends in a direction of the longitudinal extension of the wave winding wires accommodated in the receiving space, at a transfer position longitudinally offset relative to a preceding transfer position; or
positioning the workpiece carrier in the vertical direction at the transfer position such that the retaining structures overlap vertically with guide devices of the magazine.

5. A manufacturing method for manufacturing a winding mat for a coil winding of a stator, the method comprising performing the stacking method according claim 1 to obtain a stack of wave winding wires, in which stack winding heads are arranged on both sides, and embossing the stack on the workpiece carrier in the region of the winding heads.

6. A magazine for use in the stacking method according to claim 1, comprising:
a meander-shaped receiving space for a plurality of similar wave winding wires with lateral guide devices for at least one of exactly guiding or laterally positioning the wave winding wires without tensioning, the receiving space extending vertically through the magazine at least with one directional component;
a storage guide device configured to receive a wave winding wire at a depositing position offset from the receiving space in a transverse direction extending transversely to a longitudinal extension of the meander-shaped receiving space, and a receiving recess for receiving a workpiece carrier with a retaining structure diving into the magazine from below.

7. The magazine according to claim 6, wherein the receiving space is formed by a boundary of a plurality of exchangeable segmented magazine parts.

8. The magazine according to claim 6, further comprising:
a separating device for laterally displacing a lowermost wave winding wire from the receiving space to a depositing position with force application points configured to maintain the geometry of the wave winding wire;
a slider movable to reciprocate in the transverse direction as a support for at least one of
preventing the wave winding wires from falling out of the receiving space downwards, or
separating the lowermost wave winding wire by lateral displacement from the receiving space to the depositing position.

9. A stacking device for carrying out the stacking method according to claim 1, comprising:
at least one magazine comprising:
a meander-shaped receiving space for a plurality of similar wave winding wires with lateral guide devices for at least one of exactly guiding or laterally positioning the wave winding wires without tensioning, the receiving space extending vertically through the magazine at least with one directional component;
a storage guide device configured to receive a wave winding wire at a depositing position offset from the receiving space in a transverse direction extending transversely to a longitudinal extension of the meander-shaped receiving space, and a receiving recess for receiving a workpiece carrier with a retaining structure diving into the magazine from below,
at least one workpiece carrier having a retaining structure for the stack of deposited wave winding wires,
at least one positioning device for relative positioning of the workpiece carrier and the at least one magazine at predetermined transfer positions;
at least one movement device for relatively moving the workpiece carrier and the at least one magazine; and
a control unit configured to control the stacking device for automatically performing the stacking method.

10. The stacking device according to claim 9, further comprising at least one of:
insertion elements for actively inserting the wave winding wire to be deposited into the retaining structure, or
a hold-down device for exerting a vertical force on the wave winding wires in the receiving space.

11. The stacking device according to claim 9, having a first magazine and a second magazine of the at least one magazine,
wherein the first magazine is configured to receive first wave winding wires and the second magazine has a differently contoured receiving space for receiving second wave winding wires different from the first wave winding wires,
wherein the movement device is configured to move the workpiece carrier between depositing positions of the first and second magazines with different displacement in a longitudinal direction.

12. A control unit for a stacking device according to claim 9, wherein the control unit is configured to control the stacking device to perform the stacking method.

13. A computing device comprising a processing unit and a memory which has stored therein computer-executable instructions for implementing control instructions to cause a stacking device according to claim 9 to perform the stacking method.

14. A manufacturing device for manufacturing a winding mat for a coil winding of a stator, comprising a stacking device according to claim 9 and a press configured to emboss, on the workpiece carrier, winding heads of a stack of wave winding wires formed on the workpiece carrier.
